(19) United States
(12) Patent Application Publication
(10) Pub. No.: US 2012/0104319 A1
(43) Pub. Date: May 3, 2012

(54) LUMINESCENT PAINTS AND METHODS OF MAKING THE SAME

(76) Inventor: David Postma, Hobart, IN (US)

(21) Appl. No.: 13/262,297

(22) PCT Filed: Mar. 30, 2010
(86) PCT No.: PCT/US10/29130

§ 371 Date: Jan. 10, 2012

Related U.S. Application Data
(60) Provisional application No. 61/165,702, filed on Apr. 1, 2009.

(51) Int. Cl. C09D 5/22

(52) U.S. Cl. 252/301.36

(57) ABSTRACT

Luminescent paints and methods of making luminescent paints are provided. In some examples, the luminescent paints may include epoxy resin and luminescent substance. The luminescent paints may also include a variety of day time, UV stable colors.

### RELATED APPLICATIONS

The present application claims the benefit of co-pending PCT Patent Application No. PCT/US10/29130, filed Mar. 30, 2010, which claims the benefit of U.S. Provisional Patent Application No. 61/165,702, filed Apr. 1, 2009, the entire contents of all are hereby incorporated herein by reference.

### FIELD OF THE INVENTION

The present invention generally relates to paints and, more particularly, to luminescent paints having color.

### BACKGROUND

Conventional luminescent paints are typically acrylic in nature and may be water or solvent based acrylics. Due to the nature of acrylic based luminescent paints, these luminescent paints lack durability, are brittle when dry, and colors fade easily. When applied to a surface, these acrylic based luminescent paints wear quickly or may begin to crack, flake, peel, or crumble, and therefore chip away. In addition, the color capabilities of acrylic based luminescent paints are limited because the water based dyes compatible with such acrylic and water based luminescent paints are not ultraviolet (UV) stable and will fade in a relatively short period of time (e.g., 2 months) with exposure to ultraviolet rays (e.g., from sunlight or artificial light). Some acrylic based luminescent paints may include a UV inhibitor to inhibit fading of the color. However, such UV inhibitors reduce the effectiveness of the luminescent aspect of the paint because the UV rays are required to activate the luminescent substance within the paints and the UV rays cannot access the luminescent substance due to the UV inhibitor.

The types of surfaces to which acrylic based luminescent paints may be applied is limited by the characteristics of these paints. For example, due to the low durability of acrylic based luminescent paints, it is undesirable to apply these luminescent paints in high traffic areas. Also, for example, due to the brittleness of the acrylic based luminescent paints, it is undesirable to apply these luminescent paints to objects that may flex or otherwise deform, or to objects that may be impacted. Application of conventional acrylic luminescent paints to such objects will cause the conventional acrylic luminescent paints to flex, crack or break, and ultimately chip away. Further, for example, application of acrylic based luminescent paints in an outdoor setting or other setting where the paint it exposed to UV rays is undesirable because the paint color will fade.

### SUMMARY

The present invention resolves shortcomings of the prior art.

In one example, a luminescent paint is provided.

In another example, a method of making a luminescent paint is provided.

In a further example, an epoxy based luminescent paint is provided.

In yet another example, a method of making an epoxy based luminescent paint is provided.

In yet a further example, an epoxy based luminescent paint is provided and includes an epoxy base or resin, an anti-settling agent, and a luminescent substance.

In a still further example, a method of making a luminescent paint is provided and includes providing a quantity of an anti-settling agent, mixing a quantity of epoxy resin with the quantity of anti-settling agent, and mixing a quantity of luminescent substance with the mixture of anti-settling agent and epoxy resin.

In still another example, a luminescent paint is provided and includes a two component composition comprising an epoxy component and an activator component. The epoxy component may include an anti-settling agent, an epoxy resin, and a luminescent substance.

In another example, a luminescent paint composition is provided and includes epoxy resin and luminescent substance.

In a further example, a luminescent paint composition is provided and includes an epoxy component including epoxy resin and luminescent substance, and an activator, wherein the epoxy component and the activator are mixed together.

In yet another, a luminescent paint having a composition comprising, as a percentage by weight about 25% to about 95% epoxy resin and about 1% to about 60% luminescent substance.

In yet a further example, a luminescent paint having a composition comprising, as a percentage by weight about 51% to about 67% epoxy resin, about 10% to about 35% anti-settling agent, about 0.2% to about 5% dye, and about 17% to about 22% luminescent substance.

### BRIEF DESCRIPTION OF THE DRAWINGS

FIG. 1 is a perspective view of an exemplary environment in which epoxy based luminescent paint embodying the present invention may be applied, the exemplary environment comprises a building stairwell including stairs, a handrail, a landing, a riser, a door frame, and a sign;

FIG. 2 is a cross-sectional schematic of an exemplary application of the epoxy based luminescent paint to an exemplary object;

FIG. 3 is a cross-sectional schematic of another exemplary application of the epoxy based luminescent paint to an exemplary object;

FIG. 4 is a cross-sectional schematic of yet another exemplary application of the epoxy based luminescent paint to an exemplary object; and

FIG. 5 is a flowchart illustrating an exemplary manner of making an epoxy based luminescent paint.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

Luminescent paints of the present invention are usable in a variety of different applications and may be applicable to a variety of different objects and materials. The luminescent paints absorb and in return emit light, which may be helpful for illuminating environments in low light conditions, and are durable, thereby resisting wear and providing a long effective life. Also, the luminescent paints may have a variety of colors capable of maintaining their vividness after exposure to light over long periods of time. Such luminescent paints may comprise an epoxy base or resin. The use of the epoxy resin provides the luminescent paint with improved durability and improved impact resistance over conventional acrylic based luminescent paints. In addition, epoxies have been proven to have superior bonding, superior compatibility with other products (e.g., primers, top coats, etc.), and a significantly longer life then acrylic based paints.

Due to the characteristics of epoxies, the exemplary epoxy based luminescent paints require a hardener or activator to be mixed with the epoxies in order to cause hardening or drying of the epoxies. The exemplary epoxy based luminescent paints of the present invention have a two component composition comprising an epoxy component and an activator component. Exemplary epoxy components will be described in detail below, while the activator component may be comprised of any of a wide variety of conventional activators. Exemplary activators include, but are not limited to, Crawford 4700 part b UO-144CN and Crawford 4805 part b UO-161 both sold by Crawford Labs of Chicago, Ill.

Exemplary epoxy components of the epoxy based luminescent paints include a luminescent substance that provides the luminescent properties of the luminescent paints. The luminescent substance may be a variety of different substances such as, for example, strontium aluminate doped with europium (SrAl₂O₄:Eu) or copper-activated zinc sulfide (ZnS:Cu). In some examples, the exemplary epoxy components may include an anti-settling agent. The anti-settling agent inhibits the particulate within the paint from settling to a bottom of a container and solidifying to an extent where the paint is unusable. Also, in some examples, the exemplary epoxy components may include dyes for coloring the luminescent paints to desired colors. Exemplary colors include, but are not limited to, blue, light blue, green, light green, blue-green, yellow, light yellow, fluorescent yellow, safety yellow, orange, red, and purple. In some instances, it may be desirable for the luminescent paints to be white in color, in which case no dye or a white dye is added to the paint.

The epoxy based luminescent paints of the present invention may be used in a variety of exemplary applications such as, for example: floors; walls; handrails; doors; door frames; base boards; various interior and exterior portions of automobiles and other motorized vehicles such as wheel rims, body paint, truck beds, calipers, etc.; various interior and exterior portions of trailers and other non-motorized vehicles; stairs; heavy machinery or equipment; personal safety equipment such as hard hats; transformers; power boxes; electric service panels; tool boxes; fire hydrants; fire extinguishers; fire extinguisher cabinets; parking lot indicia; roadway indicia; airport runway indicia; bicycle path indicia; exterior and interior portions of buildings; floor boards; light fixtures; bollards; construction related implements such as road cones, barrels, barriers and J-walls; police departments; fire departments; or other types of vertical, horizontal, angled, curved, and non-horizontal and non-vertical surfaces. The epoxy based luminescent paints may be applied to a variety of different materials such as, for example, metal, plastic, concrete, asphalt, drywall, glass, wood, ceramics, porcelain, etc.

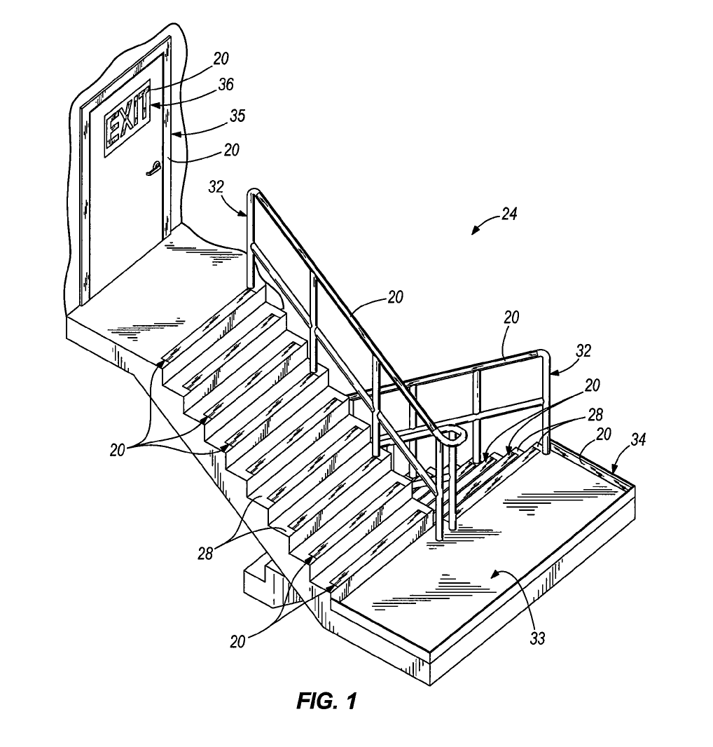

With reference to FIG. 1, exemplary applications of the epoxy based luminescent paint 20 are illustrated. More particularly, FIG. 1 illustrates a stairwell 24 in an interior of a building. The luminescent paint 20 may be applied to the stairs 28, the handrail 32, a landing 33, a riser 34, a doorframe 35, and a sign 36. Stairwells 24 are often low light environments under normal conditions. In emergency situations, such as in a fire or a loss of electricity, the stairwell 24 has even lower light conditions than under normal conditions. In such instances, the light emitted by the luminescent paint 20 on the stairs 28, handrails 32, landing 33, riser 34, doorframe 35, and sign 36 illuminates the stairwell 24 and makes it easier for occupants in the stairwell to see the stairs 28, the handrails 32, etc., and see other people within the stairwell 24. The luminescent paint 20 is durable and provides a long life on the stairs 28 under heavy foot traffic and on the handrail 32 under heavy hand traffic.

As indicated above, the epoxy based luminescent paints of the present invention are capable of having a variety of colors, often referred to as daytime colors, that resist fading. Dyes are used to color the epoxy based luminescent paints and the dyes may be solvent or petroleum based for compatibility with the epoxy based luminescent paints. Alternatively, the dyes may be other based dyes that are compatible with the epoxy based luminescent paints. Solvent, petroleum, and other based dyes resist fading when exposed to ultraviolet rays, thereby providing the epoxy based luminescent paints containing these types of dyes with colors that have the ability to resist fading. This is contrary to conventional acrylic based luminescent paints that require water based dyes for coloring because the water based dyes are not UV tolerant and will fade easily when exposed to UV rays. The exemplary epoxy based luminescent paints of the present invention may have colors including, for example, blue, light blue, green, light green, blue-green, yellow, light yellow, fluorescent yellow, safety yellow, orange, red, purple, and white, that resist fading and have a relatively long, colorful life.

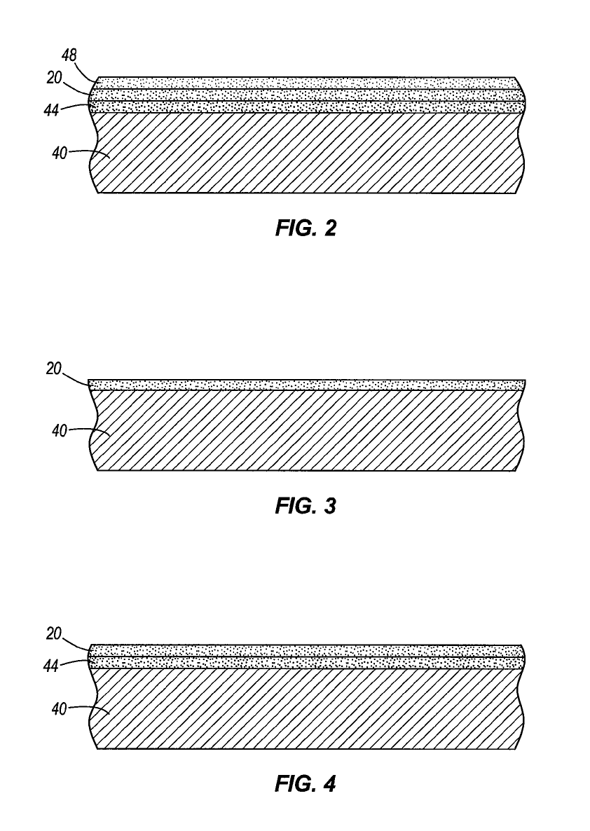

Referring now to FIG. 2, an exemplary application of the epoxy based luminescent paints 20 of the present invention is illustrated. This exemplary application is only one of a variety of different manners for applying the luminescent paints 20 to an object 40. In this example, a primer or first coat 44 is applied directly to an object 40. Since the luminescent paints of the present invention are epoxy based, the luminescent paints may be compatible with a large variety of primers such as, for example, acrylic, alkyd, enamels, urethane, epoxy, etc. Also, the primer coat 44 should be in good condition (i.e., not chipping, cracking, or peeling; free of dirt, oil, grease, and other foreign materials). In some examples, it is preferable that the primer coat 44 have a white or light silver color (described in greater detail below). Next, the epoxy based luminescent paint 20 may be applied onto the primer coat 44. In some instances, the epoxy based luminescent paint 44 may be referred to as the mid-coat. In the illustrated exemplary embodiment, a single coat or layer of epoxy based luminescent paint 20 is applied. Alternatively, any number of coats or layers of epoxy based luminescent paint 20 may be applied and be within the spirit and scope of the present invention. Finally, a top coat or clear coat 48 may be applied onto the luminescent paint 20. In some examples, the clear coat 48 may be non-yellowing with low UV inhibitors to allow maximum UV penetration therethrough. Also, in some examples, the clear coat 48 may be urethane based, epoxy based, etc. The clear coat 48 also provides some protection to the luminescent paint 20, thereby improving the paint's 20 overall durability.

In the present example, the luminescent paint 20 is applied to a primer 44. The primer 44 may be a variety of colors, but, typically, primer 44 is white. While the epoxy based luminescent paint 20 may be applied to primer 44 having any color, applying the epoxy based luminescent paint 20 to a white primer 44 may accentuate the brightness and the color of the luminescent paint 20. Silver is another color that may accentuate the brightness and the color of the luminescent paint 20. These particular primer colors and other similar colors may reflect UV rays that have passed through or by the epoxy based luminescent paint 20 back through the paint 20 to increase the paint's 20 exposure to UV rays, thereby improving charging of the luminescent substance within the paint 20.

With reference to FIG. 3, another exemplary application of the epoxy based luminescent paint 20 is illustrated. In this illustrated exemplary embodiment, the epoxy based luminescent paint 20 may be applied directly to an object 40 without a primer layer. While the luminescent paint 20 may be applied to objects 40 having any color, objects 40 having a white or silver color accentuate the brightness and color of the luminescent paint 20 more than other colors for reasons similar to those described above relating to primer colors.

In instances where an object 40 may not have a desirable color, a primer coat 44 may first be applied to the object 40, then the epoxy based luminescent paint 20 may be applied over the primer coat 44 as illustrated in FIG. 4. A top or clear coat 48 may not be desired in all instances for a variety of reasons such as, for example, the epoxy based luminescent paint 20 is self-sealing and may not require a clear coat 48 for protection or added durability.

The following description identifies exemplary compositions of epoxy components of the exemplary epoxy based luminescent paints. The following examples are not intended to be limiting upon the present invention and the epoxy components of the exemplary epoxy based luminescent paints of the present invention are capable of having other compositions.

An exemplary epoxy component of an epoxy based luminescent paint includes an epoxy resin, an anti-settling agent, and a luminescent substance. The epoxy resin may be a variety of available epoxy resins. In the present example, the epoxy resin may be #4805 MO-091 epoxy resin sold by Crawford Labs of Chicago, Ill. Alternatively, the epoxy resin may be #4700 MO-076 epoxy resin also sold by Crawford Labs. Also in the present example, the anti-settling agent may be Y25X anti-settling product manufactured by Southern Clay Products, Inc. of Gonzales, Tex. 78629. Alternatively, the anti-settling agent may be Y-20XP also manufactured by Southern Clay Products, Inc. or Disparlon 4200-20 manufactured by King Industries of Norwalk, Conn. Further in the present example, the luminescent substance may be strontium aluminate europium and may be one of a variety of products manufactured by MPK Co. of Clayton, Wis. Such examples of the luminescent substance include the following MPK Co. products: MMHSB-8D; MMHSB-9D; MMHSB-9C; MMHB-4B; MMHG-5B; MMSWW-4D. In these examples of the luminescent substance, the number immediately following the “-” in the product numbers represents a color and the letter following the number represents the size of the luminescent substance particle. For example, the letter “B” represents the largest particle size and the letter “E” represents the smallest particle size with the letters between “B” and “E” representing particle sizes decreasing in size from “B” to “E”. The larger the luminescent substance particle size the longer and brighter the luminescent substance particle will emit light. Different luminescent substance particle sizes are used for different colors of the exemplary epoxy components. The luminescent substance particle size selected for each color of paint was selected because it performed best with that particle color. Alternatively, the present example may include luminescent substance products manufactured by other entities such as WGR1-OW-12-18 manufactured by Color Technology of Howell, N.J. 07731 or MR-1 manufactured by Yangzhou Huahan Plastic Colour Masterbatch Co. Ltd. of Yangzhou City, Jiangsu Province, China.

The exemplary epoxy components may have a variety of different colors and the compositions of the epoxy components differ depending on the desired color. Dyes may be added to the epoxy components in order to establish a desired color other than white. A variety of different types of dyes may be used to obtain the desired color of the epoxy based luminescent paint. The dyes identified below are for exemplary purposes and are not intended to be limiting upon the present invention.

The following exemplary colors and compositions of the epoxy components are for illustrative purposes only and provide only some of the many possible colors and compositions associated with the exemplary epoxy components.

If a white epoxy based luminescent paint is desired, the epoxy component may include the following quantities of elements: 108 liquid ounces of epoxy resin, 20 liquid ounces of anti-settling agent, and 1 kilogram of MMSWW-4D luminescent substance. As indicated above, dye may not be added if white is the desired color of the luminescent paint. Alternatively, a white dye may be added if desired.

If a blue epoxy based luminescent paint is desired, the epoxy component may include the following quantities of elements: 102 liquid ounces of epoxy resin, 20 liquid ounces of anti-settling agent, 6 liquid ounces of 03248 dye manufactured by SEM Products, and 1 kilogram of MMHSB-8D luminescent substance.

If a light blue epoxy based luminescent paint is desired, the epoxy component may include the following quantities of elements: 105 liquid ounces of epoxy resin, 20 liquid ounces of anti-settling agent, 3 liquid ounces of 03248 dye manufactured by SEM Products, and 1 kilogram of MMHSB-9C luminescent substance.

If a green epoxy based luminescent paint is desired, the epoxy component may include the following quantities of elements: 102 liquid ounces of epoxy resin, 20 liquid ounces of anti-settling agent, 6 liquid ounces of 03248 dye manufactured by SEM Products, and 1 kilogram of MMHG-5B luminescent substance.

If a light green epoxy based luminescent paint is desired, the epoxy component may include the following quantities of elements: 105 liquid ounces of epoxy resin, 20 liquid ounces of anti-settling agent, 3 liquid ounces of 03248 dye manufactured by SEM Products, and 1 kilogram of MMHG-5B luminescent substance.

If a fluorescent yellow epoxy based luminescent paint is desired, the epoxy component may include the following quantities of elements: 102 liquid ounces of epoxy resin, 20 liquid ounces of anti-settling agent, 6 liquid ounces of 03278 dye manufactured by SEM Products, and 1 kilogram of MMHG-5B luminescent substance.

If a yellow epoxy based luminescent paint is desired, the epoxy component may include the following quantities of elements: 102 liquid ounces of epoxy resin, 20 liquid ounces of anti-settling agent, 6 liquid ounces of Planet Color PCLD5 dye manufactured by Sherwin-Williams Automotive Finishes Corp. of Cleveland, Ohio, and 1 kilogram of MMHG-5B luminescent substance.

An alternative yellow epoxy based luminescent paint includes an epoxy component having similar quantities of elements as the previous yellow paint, however, this alternative yellow paint includes an epoxy component having an alternative luminescent substance. More particularly, this epoxy component of the alternative yellow paint includes 1 kilogram of MMSWW-4D luminescent substance.

If a light yellow epoxy based luminescent paint is desired, the epoxy component may include the following quantities of elements: 102 liquid ounces of epoxy resin, 20 liquid ounces of anti-settling agent, 6 liquid ounces of 03278 dye manufactured by SEM Products, and 1 kilogram of MMSWW-4D luminescent substance.

If an orange epoxy based luminescent paint is desired, the epoxy component may include the following quantities of elements: 102 liquid ounces of epoxy resin, 20 liquid ounces of anti-settling agent, 6 liquid ounces of Planet Color PCLD5 dye manufactured by Sherwin-Williams Automotive Finishes Corp., 16 grams of Parasol Red EG Solvent Red 135 manufactured by Paramount Colors Inc. of Elk Grove Village, Ill. 60007, and 1 kilogram of MMHG-5B luminescent substance.

An alternative orange epoxy based luminescent paint includes an epoxy component having similar quantities of elements as the previous orange paint, however, this alternative orange paint includes an alternative luminescent substance. More particularly, this alternative orange paint includes 1 kilogram of MMSWW-4D luminescent substance.

Another alternative orange epoxy based luminescent paint includes an epoxy component having similar quantities of elements as the previous orange paints, however, the epoxy component of this alternative orange paint includes a combination of luminescent substances to arrive at 1 kilogram of total luminescent substance mass. More particularly, the epoxy component of this alternative orange paint includes 0.75 kilograms of MMSWW-4D luminescent substance and 0.25 kilograms of WGR1-OW-12-18 Color Technology luminescent substance.

If a purple epoxy based luminescent paint is desired, the epoxy component may include the following quantities of elements: 102 liquid ounces of epoxy resin, 20 liquid ounces of anti-settling agent, 4 liquid ounces of 03238 dye manufactured by SEM Products, 2 liquid ounces of Planet Color PCLD8 dye manufactured by Sherwin-Williams Automotive Finishes Corp., 0.75 kilograms of MMSWW-4D luminescent substance, and 0.25 kilograms of WGR1-OW-12-18 Color Technology luminescent substance.

In some exemplary embodiments, another substance or filler may be added to the epoxy based luminescent paint in order to provide additional beneficial characteristics to the epoxy based luminescent paint. Such beneficial characteristics may include, for example, thickening the paint so less coats or layers of paint are required to provide adequate coverage, increasing durability of the paint, increasing uniformity of the paint, assisting with color retention, and increasing the paint's chemical and stain resistance. The filler may be a variety of different products including, for example, silica flour, Nepheline Syenite, etc. One of the many examples of silica flour useable with the epoxy based luminescent paint may include silica flour provided by AGSCO of Wheeling, Ill. Two of the many examples of Nepheline Syenite useable with the epoxy based luminescent paint may include Minex 3 and Minex 4 provided by Uninim Specialty Minerals, Inc. of New Canaan, Conn. The filler may be added to any of the exemplary epoxy based luminescent paints described above and other possible epoxy based luminescent paints of the present invention. Also, various quantities of filler may be added to the epoxy based luminescent paints. In one exemplary embodiment, 500 grams of filler per gallon of paint may be added to the epoxy based luminescent paint. In other exemplary embodiments, anywhere from 0.1 grams to 1000 grams of filler per gallon of paint may be added to the epoxy based luminescent paint. Other quantities of filler are contemplated and are within the intended spirit and scope of the present invention. The full quantity of filler added to the epoxy based luminescent paint may be comprised of either a single type of filler or may be comprised of multiple types of filler. For example, in instances where a single type of filler is added, the total quantity of filler may be comprised of silica flour or the total quantity of filler may be comprised of Nepheline Syenite. Also for example, in instances where multiple types of filler are added, a first portion of the total quantity of filler may be comprised of silica flour and the remaining portion of the filler may be comprised of Nepheline Syenite. The filler may also be comprised of a wide variety of different particle sizes. In some exemplary embodiments, the size of the particles comprising the filler may be between about 37 microns and about 74 microns. Other particle sizes of the filler are possible and are within the spirit and scope of the present invention. Smaller particle sizes may be desired in applications where a smooth, non-gritty epoxy based luminescent paint is desired. One such exemplary application may include automotive exterior paint. Larger particle sizes may be desired in applications where a rougher, gritty, and/or anti- skid epoxy based luminescent paint is desired. One such exemplary application may include steps in a stairwell.

In the above exemplary colors of exemplary epoxy components of the epoxy based luminescent paints, the various elements of the epoxy components comprise the following percentages of the total weight of the epoxy components: epoxy resin comprises between about 51% and about 67% of the total weight; anti-settling agent comprises between about 10% and about 13% of the total weight; dye comprises between 0% and about 5% of the total weight; filler comprises between about 0% and about 18% of the total weight; and luminescent substance comprises between about 17% and about 22% of the total weight. Alternatively, the various elements of the epoxy components may comprise other percentages of the total weight of the epoxy components. For example, the various elements may comprise the following percentages of the total weight of the epoxy components: epoxy resin may comprise between about 25% and about 95% of the total weight; anti-settling agent may comprise between about 7% and about 35% of the total weight; dye may comprise between 0% and about 10% of the total weight; filler may comprise between about 0% and about 35%; and luminescent substance may comprise between about 1% and about 60% of the total weight.

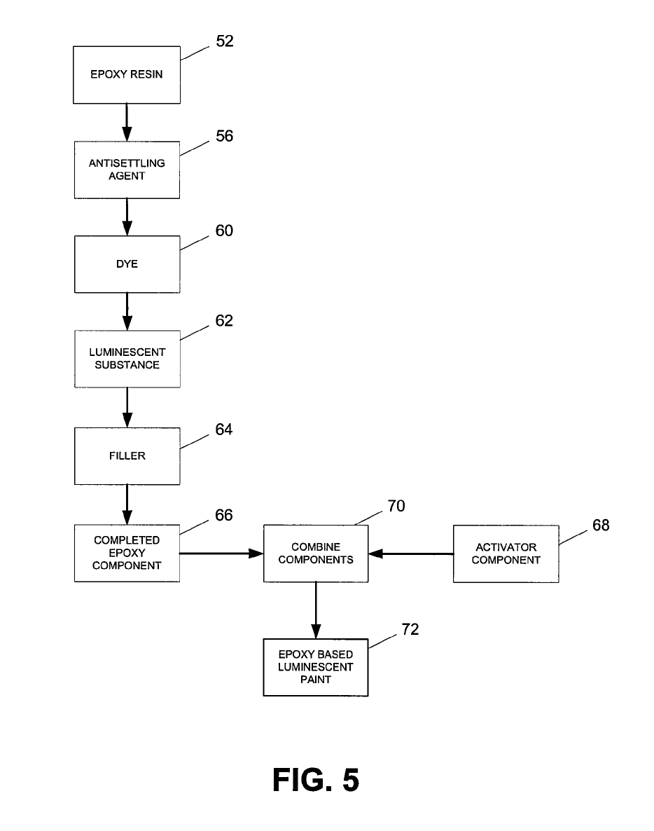

With reference to FIG. 5, an exemplary method of making an exemplary epoxy based luminescent paint is illustrated and will be described herein. This is only one of many different methods of making epoxy based luminescent paints of the present invention and this example is not intended to be limiting. Many other methods of making epoxy based luminescent paints are contemplated and are within the spirit and scope of the present invention.

The first step in this exemplary method of making epoxy luminescent paint includes beginning with the full quantity of epoxy resin (step 52). For this exemplary epoxy based luminescent paint, the full quantity of epoxy resin varies depending on the desired color of the luminescent paint. Next, the full quantity of anti-settling agent is added to the epoxy resin (step 56). The epoxy resin and anti-settling agent are mixed until evenly blended. The contents of this epoxy based luminescent paint may be mixed in a variety of manners such as, for example, stirring or shaking. In some examples, stirring may be performed with a plastic stirring element. If the epoxy based luminescent paint is to have a color other than white, the full quantity of dye is added to the mixture of epoxy resin and anti-settling agent (step 60). The type and quantity of dye added to the epoxy resin and anti-settling agent depends on the desired color of the luminescent paint. If dye is added, the dye, epoxy resin, and anti-settling agent are mixed until evenly blended. After the dye is evenly blended with the epoxy resin and anti-settling agent, the total amount of the luminescent substance is added to the mixture (step 62). The luminescent substance is mixed into the mixture until it is evenly blended. Upon creating an evenly blended mixture including all the above contents, an exemplary epoxy component of the exemplary epoxy based luminescent paint is completed (step 66). The amount of time required to make this exemplary epoxy component may vary. In some examples, about 5 minutes of mixing may be required after each element of the epoxy component is added to the mixture, thereby establishing a total mixing time of about 15 to 25 minutes. Other mixing times are possible and are within the intended scope of the present invention.

With continued reference to FIG. 5, now that the exemplary epoxy component of the exemplary epoxy based luminescent paint is completed, the activator component 68 may be combined with the epoxy component (step 70) at a desired ratio. In some examples, the epoxy component and the activator component are mixed at a 3-part epoxy component to 1-part activator component ratio. In other examples, the epoxy component and the activator component are mixed at a 4-part epoxy component to 1-part activator component ratio. It should be understood that the epoxy component and the activator component may be mixed at a variety of different ratios and be within the intended spirit and scope of the present invention. The exemplary ratios described herein are not intended to be limiting. Upon completing an evenly blended mixture of the epoxy component and the activator component at the desired ratio, the exemplary epoxy based luminescent paint is completed (step 72). In some examples, about 5 minutes of mixing may be required after the epoxy component and the activator component are added together, thereby establishing a total mixing time of about 20 to 30 minutes for arriving at the completed mixture of the exemplary epoxy based luminescent paint. Other mixing times are possible and are within the intended scope of the present invention.

It should be understood that the previously described method of making the exemplary epoxy based luminescent paint is for exemplary purposes only and that the elements of the paint may be mixed in different amounts and in different orders and still be within the spirit and scope of the present invention. For example, dye may be added at anytime during the paint making process of the above exemplary epoxy based luminescent paints. Also, for example, quantities of the elements other than their full quantities may be added to the mixture at various times throughout the paint making process. For example, a portion of the epoxy resin may be initially mixed with the anti-settling agent and the remaining amount of epoxy resin may be introduced into the mixture later in the process such as, for example, after introducing the dye or after intruding the luminescent substance.

The exemplary epoxy based luminescent paints of the present invention may be characterized in a variety of different manners. A first exemplary manner of characterizing the exemplary epoxy based luminescent paints is determining the elements of the epoxy components that are solvents and non-solvents, and determining their quantities or percentages of the epoxy components by total weight. In the exemplary epoxy components described above, the solvents may be present in the dye and the anti-settling agent, and the non-solvents may comprise the epoxy resin, the luminescent substance, and portions of the dye and the anti-settling agent. The solvents and non-solvents used in the exemplary epoxy components of the exemplary epoxy based luminescent paints are exemplary and a variety of other solvents and non-solvents may be used with the epoxy components and still be within the spirit and scope of the invention. In the exemplary epoxy components, the solvents in combination comprise between about 10% and about 16% of the total weight of the epoxy components, and the non-solvents in combination comprise between about 84% and about 90% of the total weight. Alternatively, the solvents and non-solvents may comprise other percentages of the total weight of the epoxy components. For example, the solvents in combination may comprise between about 1% and about 50% of the total weight of the epoxy components. Also, for example, the non-solvents in combination may comprise between about 50% and about 99% of the total weight of the epoxy components.

As indicated above, the exemplary epoxy based luminescent paints comprise an epoxy component and an activator component. A second exemplary manner of characterizing the exemplary epoxy based luminescent paints is determining the elements of an epoxy based luminescent paint (i.e., a completed mixture of epoxy component and activator component) that are solvents and non-solvents, and determining their quantities or percentages of the epoxy based luminescent paint by total weight. The following percentages of solvents and non-solvents present in the exemplary mixed epoxy based luminescent paint are only exemplary percentages of a large variety of percentages possible and are not intended to be limiting. The epoxy and activator components may be mixed in variety of different quantities (as described above). The following exemplary mixture of epoxy and activator components is only one of the many possible mixtures and is not intended to be limiting. In this exemplary mixture of epoxy based luminescent paint, the epoxy component and the activator component are mixed in a 3:1 ratio. In such an example, the solvents in combination comprise between about 2% and about 5% of the total weight of this exemplary epoxy based luminescent paint, and the non-solvents in combination comprise between about 95% and about 98% of the total weight of this exemplary epoxy based luminescent paint. Alternatively, the solvents and non-solvents may comprise other percentages of the total weight of this exemplary epoxy based luminescent paint. For example, the solvents in combination may comprise between about 1% and about 10% of the total weight of this exemplary epoxy based luminescent paint. Also, for example, the non-solvents in combination may comprise between about 90% and about 99% of the total weight of this exemplary epoxy based luminescent paint. When considering that the epoxy component and the activator component may be mixed at a variety of different ratios, the percentages of solvents and non-solvents may vary widely. Accordingly, the percentage of solvents in combination, when considering all possible mixtures of epoxy and activator components, may comprise between about 1% and about 30%. Likewise, the percentage of non-solvents in combination, when considering all possible mixtures of epoxy and activator components, may comprise between about 70% and about 99%.

A third exemplary manner of characterizing the exemplary epoxy based luminescent paints of the present invention is determining the quantity of solids present in the epoxy components. The percentage of solids present in the exemplary epoxy components may be characterized by either the percentage of epoxy resin only or the percentage of total solids (i.e., sum of solids in epoxy resin, dye, anti-settling agent, filler, and luminescent substance). If characterizing the percentage of solids by the percentage of epoxy resin only, the percentage of solids present in the exemplary epoxy components comprise between about 70% and about 80% solids. Alternatively, the percentage of solids present in the epoxy components may comprise between about 50% and about 95% solids. If characterizing the percentage of solids by the percentage of the total solids in the entire epoxy components, the percentage of solids present in the epoxy components may comprise between about 70% and about 99% solids. Alternatively, the percentage of solids present in the entire epoxy components may comprise between about 55% and about 99% solids.

The higher the quantity or percentage of solids present in the epoxy component and epoxy based luminescent paints, the lower the quantity of solvents or evaporative. Solvents and evaporative may comprise volatile organic compounds (VOC's), which may qualify as a hazardous air pollutant (HAP), thus a lower percentage of VOC's may translate into a more environmentally friendly paint. When the solvents and evaporative evaporates, the solids remain. Therefore, a higher content percentage of solids in a paint, the more paint that remains after evaporation. With more paint present on an object, the paint remains on the object longer and is able to undergo more impact, thereby providing a more durable paint.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

What is claimed is:

1. A luminescent paint composition comprising:
epoxy resin; and
luminescent substance.

2. The luminescent paint composition of claim 1, further comprising an anti-settling agent.

3. The luminescent paint composition of claim 1, further comprising a filler.

4. The luminescent paint composition of claim 3, wherein the filler is comprised of at least one of silica flour and nepheline syenite.

5. The luminescent paint composition of claim 1, further comprising:
anti-settling agent; and
filler.

6. The luminescent paint composition of claim 1, further comprising:
anti-settling agent;
dye; and
filler.

7. The luminescent paint composition of claim 1, further comprising:
anti-settling agent; and
dye.

8. The luminescent paint composition of claim 1, further comprising an activator.

9. A luminescent paint composition comprising:
an epoxy component including
epoxy resin, and
luminescent substance; and
an activator;
wherein the epoxy component and the activator are mixed together.

10. A luminescent paint having a composition comprising, as a percentage by weight:
about 25% to about 95% epoxy resin; and
about 1% to about 60% luminescent substance.

11. The luminescent paint of claim 10, wherein the percentage by weight of epoxy resin is about 51% to about 67%.

12. The luminescent paint of claim 10, wherein the percentage by weight of luminescent substance is about 17% to about 22%.

13. The luminescent paint of claim 10, wherein the composition further comprises, as a percentage by weight, about 7% to about 35% anti-settling agent.

14. The luminescent paint of claim 13, wherein the percentage by weight of anti-settling agent is about 10% to about 13%.

15. The luminescent paint of claim 10, wherein the composition further comprises, as a percentage by weight, about 0.5% to about 35% filler.

16. The luminescent paint of claim 15, wherein the percentage by weight of filler is about 0.5% to about 18%.

17. The luminescent paint of claim 15, wherein the filler is comprised of at least one of silica flour and nepheline syenite.

18. A luminescent paint having a composition comprising, as a percentage by weight:
about 51% to about 67% epoxy resin;
about 10% to about 35% anti-settling agent;
about 0.2% to about 5% dye; and
about 17% to about 22% luminescent substance.

19. The luminescent paint of claim 18, wherein the composition further comprises, as a percentage by weight, about 0.5% to about 18% filler.

20. The luminescent paint of claim 18, wherein the composition further comprises an activator.
